(19) United States
(12) Patent Application Publication
(10) Pub. No.: US 2005/0162392 A1
(43) Pub. Date: Jul. 28, 2005

(54) Display system and three-dimensional display method

(76) Inventor: Bernd Spruck, Mogglingen (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/012,077

(22) Filed: Dec. 14, 2004

(30) Foreign Application Priority Data
Dec. 15, 2003 (DE) 103 58 722.5

(51) Int. Cl. G09G 5/08

(52) U.S. Cl. 345/163

(57) ABSTRACT

A display system is provided, comprising a display device for three-dimensional display of an image; a control unit which causes the image to be displayed; and an input unit connected to the control unit, via which input unit movements can be input in two space coordinates, wherein the control unit is switchable into a first mode and into a second mode differing therefrom, and wherein the control unit converts the input movements, in the first mode, into a movement of the image relative to first and second display coordinates and, in the second mode, into a movement of the image relative to at least a third display coordinate.

This application claims priority to German patent application No. 103 58 722.5 filed Dec. 15, 2003. Said application is incorporated herein in its entirety by reference.

### BACKGROUND OF THE INVENTION

The invention relates to a display system and to a method for three-dimensional display of an image.

A three-dimensional display is used, for example, in the pharmaceutical industry, to display macromolecules. In order to move macromolecules displayed in this manner, use is often made of a so-called 3D-mouse, using which movements can be input in three spatial directions. However, such a 3D-mouse is expensive and has an unusual type of input.

In view thereof, it is an object of the invention to provide an inexpensive display system and method for the three-dimensional display of an image, wherein a three-dimensional movement of the image can easily be input.

### SUMMARY OF THE INVENTION

According to the invention, the object is achieved by a display system comprising a display device for a three-dimensional, in particular stereoscopic, display of an image; a control unit which effects said display of the image; and an input unit connected to the control unit, via which input unit movements can be input in two space coordinates, wherein the control unit is switchable into a first mode and into a second mode differing therefrom, and wherein the control unit converts the input movements, in the first mode, into a movement of the image relative to first and second display coordinates and, in the second mode, into a movement of the image relative to at least a third display coordinate.

This makes it advantageously possible to carry out a three-dimensional movement of the image by a movement that is input only in two dimensions. Therefore, conventional and, thus, inexpensive input units, such as a computer mouse, a track ball, or the like, may be used to move the image to a desired three-dimensional position. The image is preferably a marker, such as a cursor. Thus, the display system according to the invention allows the movement of the image to be set independently and, as the case may be, also individually in all three display coordinates.

Thus, in the display system according to the invention a movement in relation to a maximum of two display coordinates is effected in either of said two modes of the control unit. The three-dimensional movement of the image is thus assembled from two-dimensional movements. Therefore, conventional input units, such as a computer mouse, may be used to input or provide the desired three-dimensional movement of the image.

In a preferred embodiment of the display system according to the invention, the input unit comprises a switching unit by which the control unit can be switched into the desired mode. If the input unit is provided as a computer mouse, the switching unit may be a button or other switch on the computer mouse. This allows the user to effect the three-dimensional movement quickly and precisely, without having to take his hand off the input unit (computer mouse).

Further, in the display system, the first mode allows the control unit to convert the input movement in both space coordinates into the movement of the image, and the second mode allows it to convert the input movement only in one of said two space coordinates into the movement of the image. This is advantageous in cases where, in the second mode, the image has to be moved only along an axis and no longer within a plane in order to reach the desired position.

In the preferred embodiment of the display system according to the invention, the image is stereoscopically displayed such that a first partial image for the left eye of a viewer and a second partial image for the right eye of said viewer are displayed. This makes it easy to achieve the desired three-dimensional effect. The separation of the partial images for the user is effected, for example, by means of different polarization conditions or colors in the display and by means of spectacles for the user with a polarization filter or a color filter, respectively.

Further, the display device may comprise a screen area, on which the image is displayed, wherein the three display coordinates are associated with three display axes and the screen area is located in a display plane which is defined by two of said display axes, and the third display axis extends perpendicular to the display plane. In such an orthogonal display coordinate system, a selective three-dimensional movement of the image in the displayed image is particularly easy to realize.

In particular, the movement of the image along the third coordinate axis can be realized by changing the distance of the two partial images in the display plane and/or by changing the size of the partial images. This allows an excellent three-dimensional display to be achieved.

Further, the input unit may be provided such that it allows movements to be input only in exactly two space coordinates.

In this case, the image may be a screen pointer or a marker (cursor), respectively, which is movable by means of the input unit.

In a preferred further embodiment, the control unit causes a three-dimensional display of a further image, so that the image (e.g. cursor) is spatially movable in the further image. The object is further achieved by a method for the three-dimensional display of an image wherein an input movement in two space coordinates is converted, in a first mode, into a movement of the image relative to first and second display coordinates and, in a second mode, into a movement of the image relative to at least a third display coordinate. This method allows to control a three-dimensional movement of the image by means of an input unit which can only input movements in two space coordinates, as is the case, for example, with a conventional computer mouse, a track ball, or the like.

The three-dimensional display is effected, in particular, in a stereoscopic manner.

Particularly preferably, only the input movement in one of the two space coordinates can be converted into the movement of the image in the second mode in the method according to the invention. This facilitates the three-dimensional control of the cursor in case the image can only be moved along one single display coordinate in the second mode.

Display of the image is preferably effected such that a first partial image for the left eye of the viewer and a second partial image for the right eye of the viewer are displayed.

Further, the image may be displayed in a display plane, wherein the three display coordinates are associated with three display axes and the display plane is defined by two of said display axes, and the third display axis extends perpendicular to the display plane. Such an orthogonal system of display coordinates allows the image to be moved in a three-dimensional manner with particular ease.

Further preferably, the movement of the image along the third display axis is displayed by changing the distance of the two partial images and/or by changing the size of the partial images.

In the method according to the invention the movement of the image is effected in relation to a maximum of two display coordinates in either of said two modes.

The display device may be a conventional screen, a computer screen, or even a projection system for projecting an image onto a projection surface. Further, the display device may be provided as a head-up display (e.g. for reflecting the image onto the windshield of a vehicle) or as a head-mounted display (a display device to be worn on the head). The head-mounted display (HMD) may be provided such that the user only sees the displayed image and preferably also a further displayed image, or that he can also perceive his environment upon which the image is superimposed, so that, for example, a real object can be marked by said image.

If the display device is provided as a head-mounted display, it may further comprise a so-called head tracker, using which the position of the user's head is sensed and reported to the control unit. The control unit may then cause the image to be displayed such, for example, that even if the head is moved, the same object is still marked by said image. Thus, the movement of the head is compensated for.

The display device may also be provided as an auto-stereoscopic display operating, for example, according to the line-pattern method, wherein the two partial images (left-hand view and right-hand view) are interlaced (a kind of vertical interlacing mode).

### DESCRIPTION OF THE FIGURES

Further advantages and embodiments of the invention are evident from the following detailed description of an embodiment example with reference to the attached Figures, wherein:

FIG. 1 shows a schematic view of an embodiment of the display system according to the invention;

FIG. 2 shows a schematic, three-dimensional view of the display coordinate system;

FIG. 3 shows a view explaining the determination of the positions of the partial cursor images to be displayed, and

FIGS. 4-7 show examples of the partial cursor images being displayed.

### DETAILED DESCRIPTION OF THE PREFERRED EMBODIMENTS

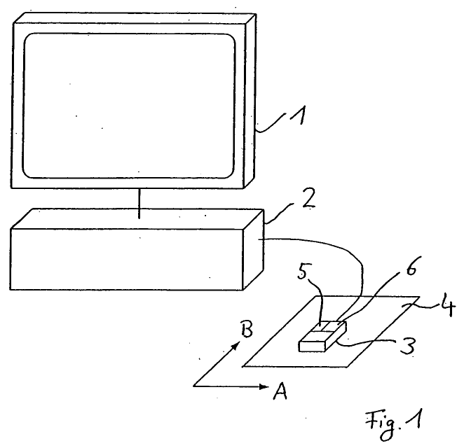

As is most clearly evident from FIG. 1, the display system comprises a display device 1 for three-dimensionally displaying an object; a control unit 2, which is a personal computer in this case, for example, and causes an image (here, for example, a cursor) to be displayed in the displayed object. The control unit 2 preferably also serves to generate the required image data for the three-dimensional display. The three-dimensional display on the display device 1 may be caused, for example, by the image information being displayed in different colors (e.g. red and green) for the right and the left eye of a viewer or by displaying different polarization conditions on the display device 1, in which case the viewer would be wearing spectacles (not shown) which comprise suitable color filters or polarization filters, respectively, so that the viewer can perceive the image information for the right eye only with his right eye and the image information for the left eye only with his left eye, thus creating the three-dimensional impression.

The display system further includes an input unit 3, which is connected to the control unit 2 and, in the presently described embodiment example, is a computer mouse 3 that is movable on a support 4. Thus, by moving the mouse on the support, a movement can be input in two different spatial directions (in this case, A and B).

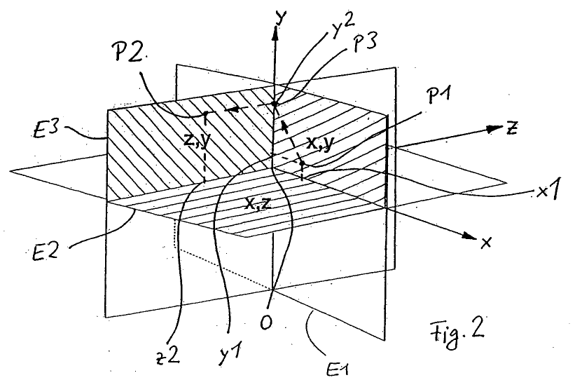

As a function of a set mode, the control unit 2 converts the two-dimensional movement input by means of the mouse 3 into a corresponding two-dimensional movement of display plane selected by said mode for three-dimensionally displaying the object. Thus, by suitably selecting the display planes, the cursor (or mouse pointer, respectively) represented in the displayed object can be moved in a three-dimensional manner. This will be described in more detail below in an example referring to FIG. 2.

FIG. 2 shows the screen plane of the display device in which the actual image display is effected as well as two display planes E2 and E3 which are perpendicular thereto. In other words, a three-dimensional display coordinate system including the display coordinate axes x, y and z is input such that the coordinate origin O is located precisely in the middle of the screen. In the example shown herein, the planes E2 and E3 are selected such that they each also contain the coordinate origin O, so that the screen plane E1 is the x,y-plane, the plane E2 is the x,z-plane and the plane E3 is the z,y-plane. It is now assumed that the cursor is located in the screen plane E1, at the point P1 having the x,y,z-coordinates (x1, y1, 0) and is to be moved to the point P2 (0, y2, z2).

For this purpose, the control unit 2 is switched into a first mode, if it is not yet in said mode already, in which the movement of the mouse in the display is converted into a movement in the screen plane E1 or into a movement relating to the display coordinates x, y, respectively. In the presently described example, the cursor is moved from point P1 to point P3 (0, y2, 0). Thereafter, the control unit 2 is switched into a second mode, for example by actuating one of the two mouse buttons 5, 6, so that the movement of the mouse 3 on the support 4 (or in the two space coordinates A, B, respectively) is now converted into a cursor movement in the displayed object with regard to the display coordinates z, y. Thus, the cursor may be moved from point P3 to point P2, as desired.

If the point P2 comprises an x-coordinate x4 which is not zero, the plane E3 would be located such that it crosses the x-axis at x4. Thus, the movement in the plane E3 would still be converted with regard to the z- and y-coordinates.

Consequently, the display system according to the invention enables a three-dimensional movement of the cursor in the displayed object by means of an input unit, which can prescribe a two-dimensional movement.

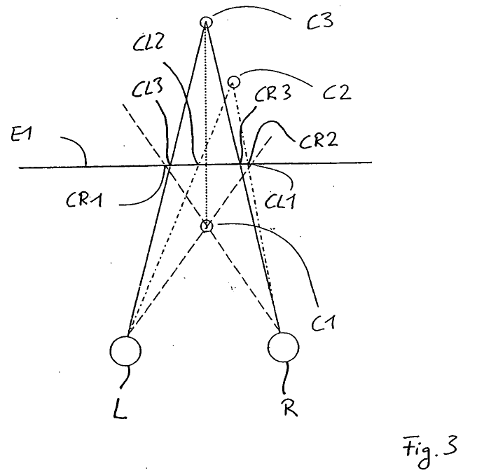

FIG. 3 shows an example of how the three-dimensional cursor position may be displayed on the two-dimensional screen surface E1 such that the desired three-dimensional position of the cursor can be perceived by the viewer. For example, if the cursor is to be displayed at position C1 (i.e. in front of the screen plane, as seen by the viewer), the respective point where the line of sight intersects the image plane E1 is determined for the right and the left eye R, L of the viewer. At said points of intersection CR1 (for the right eye) and CL1 (for the left eye), respective partial cursor images a, b, for the right and left eye, respectively, are displayed. If the three-dimensionally displayed cursor is to be a sphere, the partial cursor images will be circles (filled circles). Likewise, the display locations CL2, CR2, CL3 and CR3 of the cursor positions C2 and C3 indicated in FIG. 3 are determined in the screen plane E1.

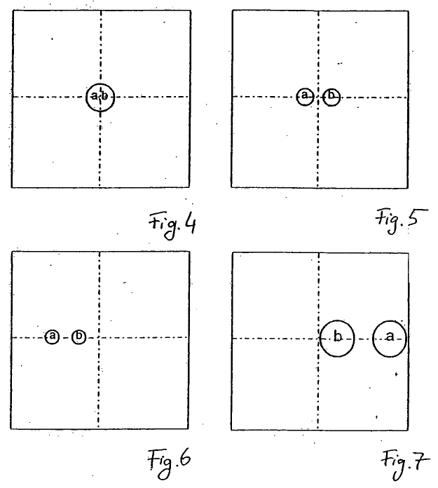

This type of display will be explained in more detail with reference to FIGS. 4 to 7, which respectively show one view of the screen plane E1. If the three-dimensional cursor is to be displayed at the center of the screen (coordinate origin), the two partial cursor images a and b, which are circles again, will be displayed as overlapping (FIG. 4). If the three-dimensional cursor is to be displayed behind the screen plane E1, the partial cursor images a and b will be spaced apart from each other (FIG. 5), their spacing increasing as the distance from the screen plane E1 increases. FIG. 6 shows a three-dimensional cursor position on the left, behind the coordinate origin in the screen plane E1, while FIG. 7 shows a cursor position on the right, in front of the coordinate origin O. A comparison of FIGS. 5 and 7 further shows that the size of the partial cursor images can be varied according to the distance from the viewer (the closer the cursor is to the viewer in the three-dimensional display, the greater is its displayed size). Further, the partial cursor image for the left eye is located to the left of the partial cursor image b for the right eye, when the cursor is displayed behind the screen plane. If the cursor is displayed in front of the screen plane E1, the opposite applies.

In a further embodiment (not shown), the display device 1 may be a so-called head-mounted display (a display device to be worn on the head). In this case, for example, two display surfaces may be provided, one for each eye, so that a separation via colors, polarization conditions, etc. is no longer required.

If the display device 1 is provided as a head-mounted display, the display is effected such that the partial cursor images a in FIGS. 4 to 7 are faded in exclusively for the left eye of the user, and the partial cursor images b are faded in exclusively for the right eye of the user. Thus, the stereo image of the cursor is generated for the viewer looking into the head-up display with both eyes.

Of course, the partial cursor images need not be circles. Any desired shape is possible. For example, circular rings may be used for the partial cursor images. If the circular ring which appears three-dimensional is sufficiently thin, it can mark, for example one of the planes E1-E3 (the circular ring is located within said plane). In the other two planes, marking is then effected by means of the center of the circular ring.

Although the description above contains many specificities, these should not be construed as limiting the scope of the invention but as merely providing illustrations of some of the presently preferred embodiments of the invention. Thus, the scope of the invention should be determined by the appended claims and their legal equivalents, rather than by the examples given.

1. A display system comprising:
a display device for three-dimensional display of an image;
a control unit which effects said display of the image; and
an input unit connected to the control unit, via which input unit movements can be input in two space coordinates, wherein the control unit is switchable into a first mode and into a second mode differing from the first mode, and wherein the control unit converts the input movements, in the first mode, into a movement of the image relative to first and second display coordinates and, in the second mode, into a movement of the image relative to at least a third display coordinate.

2. The display system as claimed in claim 1, wherein the input unit comprises a switching unit by which the control unit can be switched into the first and second modes.

3. The display system as claimed in claim 1, wherein the control unit converts the input movements, in the first mode, into an image movement relative to the first and second display coordinates and, in the second mode, only relative to the third display coordinate.

4. The display system as claimed in claim 1, wherein the image is displayed such that a first partial image for the left eye of a viewer and a second partial image for the right eye of said viewer are displayed.

5. The display system as claimed in claim 1, wherein the display device comprises a screen area, on which the image is displayed, wherein the three display coordinates are associated with three display axes and the screen area is located substantially in a display plane and the display plane is defined by a first and second of said display axes, and the third display axis extends perpendicular to the display plane.

6. The display system as claimed in claim 5, wherein a perceived movement of the image along the third display axis is generated by changing the distance between the first and second partial images in the display plane.

7. The display system as claimed in claim 5, wherein a perceived movement of the image along the third display axis is generated by changing the size of the partial images.

8. The display system as claimed in claim 6, wherein the perceived movement of the image along the third display axis is also generated by changing the size of the partial images.

9. The display system as claimed in claim 1, wherein the input unit is provided such that it allows movements to be input only in exactly two space coordinates.

10. The display system as claimed in claim 1, wherein the control unit causes a further image to be displayed in a three-dimensional manner, the image being movable relative to the further image.

11. A method for the three-dimensional display of an image comprising the steps of:
converting an input movement in two space coordinates, in a first mode, into a movement of the image relative to first and second display coordinates; and
converting a second input movement in a second mode, into a movement of the image relative to at least a third display coordinate.

12. The method as claimed in claim 11, further comprising the step of converting only the input movement in one of the two space coordinates into the movement of the image.

13. The method as claimed in claim 11, further comprising the step of displaying the image such that a first partial image for the left eye of a viewer and a second partial image for the right eye of said viewer are displayed.

14. The method as claimed in claim 12, further comprising the step of displaying the image such that a first partial image for the left eye of a viewer and a second partial image for the right eye of said viewer are displayed.

15. The method as claimed in claim 11, further comprising the step of associating the three display coordinates with three display axes and generating the image in a screen area located in a display plane defined by a first and second of said display axes, and wherein a third of said display axes extends perpendicular to the display plane.

16. The method as claimed in claim 15, further comprising the step of generating a perceived movement of the image along the third display axis by changing a separation distance between the first and second partial images in the display plane.

17. The method as claimed in claim 15, further comprising the step of generating a perceived movement of the image along the third display axis by changing the size of the first and second partial images.

18. The method as claimed in claim 16, further comprising the step of generating the perceived movement of the image along the third display axis by also changing the size of the first and second partial images.
